(19) United States
(12) Patent Application Publication
(10) Pub. No.: US 2024/0327739 A1
(43) Pub. Date: Oct. 3, 2024

(54) LOOP LINE FOR H2S TREATMENT

(71) Applicant: CONOCOPHILLIPS COMPANY, Houston, TX (US)

(72) Inventor: Jiang WANG, Houston, TX (US)

(73) Assignee: CONOCOPHILLIPS COMPANY, Houston, TX (US)

(21) Appl. No.: 18/615,568

(22) Filed: Mar. 25, 2024

Related U.S. Application Data
(60) Provisional application No. 63/492,378, filed on Mar. 27, 2023.

(51) Int. Cl. C10L 3/10; B01D 53/14; B01D 53/18

(52) U.S. Cl. CPC C10L 3/103; B01D 53/1468; B01D 53/18; B01D 2252/204; B01D 2256/245; B01D 2257/304; C10L 2290/14; C10L 2290/541; C10L 2290/565; C10L 2290/60

(57) ABSTRACT

The disclosure provides novel method for removal of H₂S from natural gas or other fluid in an oil and gas production facility by the use of a loop line method whereby the fluid passes through a looped pipeline containing H₂S scavenger thereby increasing the contact time of the H₂S scavenger with the gas and thus increasing the efficiency of the removal of H₂S from the gas. The loop line can be added to a facility with an existing H₂S scavenger direct injection line and can also be a standalone H₂S scavenger method.

### PRIOR RELATED APPLICATIONS

This application claims priority to U.S. Ser. No. 63/492,378, filed Mar. 27, 2023 and incorporated by reference in its entirety for all purposes.

### FEDERALLY SPONSORED RESEARCH STATEMENT

Not applicable.

### FIELD OF THE DISCLOSURE

The disclosure generally relates to methods for H₂S treatment, more specifically a novel method of using a loop line to inject H₂S scavenger chemicals into hydrocarbon lines to achieve efficient removal of H₂S from hydrocarbons, such as natural gas. The loop line method allows the hydrocarbon to pass through a pipeline with multiple loops thereby increasing the contact time of the H₂S scavenger with the hydrocarbon in the pipeline and in turn increasing the efficiency of the removal of H₂S.

### BACKGROUND OF THE DISCLOSURE

Hydrogen Sulfide (H₂S) is a naturally occurring gas that has the odor of rotten eggs. It is colorless, flammable, and highly toxic—acting by inhibiting cellular respiration in a manner similar to hydrogen cyanide. It is commonly found in petroleum and natural gas, which are called “sour” if they have a high percentage of H₂S (≥4 ppm).

In addition to being very poisonous, H₂S causes corrosion in carbon steel pipelines, and this can significantly reduce the service life of the pipeline and processing facilities. The interstate pipeline specifications for H₂S in the US varies between states but falls between 0.25 grains (4.12 ppm) per 100 cubic feet to 0.1 grains (1.65 ppm). However, natural gas can contain up to 28% H₂S gas, thus it is important to remove H₂S from the natural gas for longevity of pipelines in oil and gas processing facilities, as well as to meet regulatory, safety and environmental concerns.

H₂S removal or mitigation—commonly known as H₂S scavenging or sweetening—can be classified in 2 categories—regenerative and non-regenerative methods. Regenerative methods include amine wash using a scavenger tower. In this popular method, sour gas is passed through a column filled with an amine solution which reacts with H₂S to form salts. A multiple step reaction process ultimately produces a gas stream for disposal with reduced amounts of H₂S. Due to the large size of the columns and reactor space, this method is used for high gas volume removal process, as well as in higher gas flow rate systems (>5 MMSCF).

Another regenerative method for removal of H₂S involves the use of redox reactions. In this method, the gas with H₂S is passed through a column containing redox systems of iron and chelating agents. The redox columns contain metal oxide beds and H₂S reacts with the metal oxides to produce metal sulfides, as shown in equation Eq. 1 below. The sulfide salts are then sent to regeneration tower to get regenerated metal oxides for H₂S treatment.

H₂S+MO*→H₂O+MS Eq. 1.

*The metal oxide MO here does not strictly refer to stoichiometric ratios of compounds, for example, MO may also stand for Fe₂O₃.

The application of regenerative methods generally requires the use of large scavenger towers (also known as scavenger columns or bubble towers) on site. The cost of building the scavenger towers is high, and thus scavenger towers are typically used in facilities where more sour gas is produced, and where there are no space constrictions.

Non-regenerative methods for the removal of H₂S include the use of chemicals like aldehydes, triazines, buffered nitrate/nitrite solutions, solutions of NaOH and KOH, biosulfides, and amine-aldehyde combination chemicals, which are generally applied via direct injection (DI) to a pipeline and thus used at sites with existing piping. However, a minimum length of straight pipeline is needed (at least 100 feet in length and preferably about 200 feet or more) so the chemicals have sufficient contact time with the hydrocarbons in order to provide efficient scavenging. In addition, the chemicals are spent during H₂S scavenging and need to be constantly replenished. Thus, non-regenerative methods are mostly used when the concentration of H₂S in the gas is lower because the chemical costs may be prohibitive, and where there are existing pipelines of sufficient length for gas injection.

What is needed in the art are efficient and more cost-effeetive methods for treatment of H₂S in pipelines. The ideal method would be cost effeetive, require limited space, eliminate, or reduce significantly the H₂S concentration, would be easy to install, reliable and have high efficiency. This invention addresses one or more of these needs.

### SUMMARY OF THE DISCLOSURE

Described herein is a novel method for the remediation of H₂S in e.g., natural gas from oil and gas production facilities by the use of a loop line wherein the H₂S scavenger is injected into the hydrocarbon stream through an injection quill and is mixed with the gas phase while flowing through the loop line. Existing DI injection facilities can be fitted with connections and loop line of varying number of loops, lengths, and material to increase the efficiency of H₂S scavenger used in the facility. The loop line method described herein can also be applied in facilities with low gas flow rates or applied in conjunction with a direct injection line.

In one example, a loop line of suitable corrosion resistant material is installed in a facility with an existing direct H₂S scavenger injection point. The natural gas first passes through a straight pipeline (usually 100-200 ft in length, but may be much shorter since combined with a downstream loop line) with H₂S scavenger injection, followed by H₂S detection at a sampling point. After the first injection, the H₂S scavenger is introduced to another injection point, typically with an amount less than that at the direct injection point since some H₂S has already been removed. The gas passes through a loop line after the second injection.

The loop line is preferably wound around a spool with a diameter of at least 4-5 or 6 feet or more. This avoids tight turns that may be experienced in existing lines, when not specifically developed for this application, and thus avoids the loss of chemical that occurs when turbulent flow occurs at tight bends and junctions or at abrupt slope changes.

To minimize slope changes, we tested horizontal loops and the data presented herein was generated with horizontal loops. However, we have also tested vertically oriented loops, and these were possibly even more efficacious than horizontal loops. Thus, vertical loops may be preferred.

The incoming gas should have high enough flow velocity to carry all the liquid scavengers into the gas phase and mix well during the flow, yet not fall out of the gas phase at bends or at areas of abrupt slope change. Gas flow velocity is controlled by choosing different pipe diameters based on the gas production rate. The goal is to make sure the gas flow rate is within the optimized range (1-10 MMSCF, preferably about 5 MMSCF), and this can be tested in a lab or in the field, and flow rate, piping length and diameter, spool core size, etc. adjusted as needed to optimize scavenging efficiency.

The time required for the gas to pass through the loop is several minutes to hours, based on the number of loops, length of the pipe and flow rate. H₂S concentration is again determined at a second sampling point downstream of the loop line. The concentration of H₂S at the second sampling point after the gas passes through the loop line is significantly lower than at the first sampling point after the straight pipe section. Ideally, no H₂S is detected after the gas passes through the loop line.

In another example, a standalone loop line is installed, with a scavenger direct injection point just upstream of the loop or at or near the beginning of the loop. After the gas passes through the separator, and an initial amount of H₂S is measured, H₂S scavenger is injected and the gas directly sent to loop line with varying number of loops, as already described. The H₂S concentration is then again measured after the gas exits the loop line. This type of standalone loop line injection is beneficial in facilities with limited space, or with low to medium H₂S levels, or low gas flow rate (<5 MMSCF).

Any known or to be developed H₂S scavenger injection can be used in the loop line method. Water-soluble H₂S scavengers are commonly used. Examples include triazine-based chemicals. Triazines from monoethanolamine (MEA) react efficiently with the H₂S in liquid phase to produce dithiazine compounds and an amine that can be transported in the pipeline.

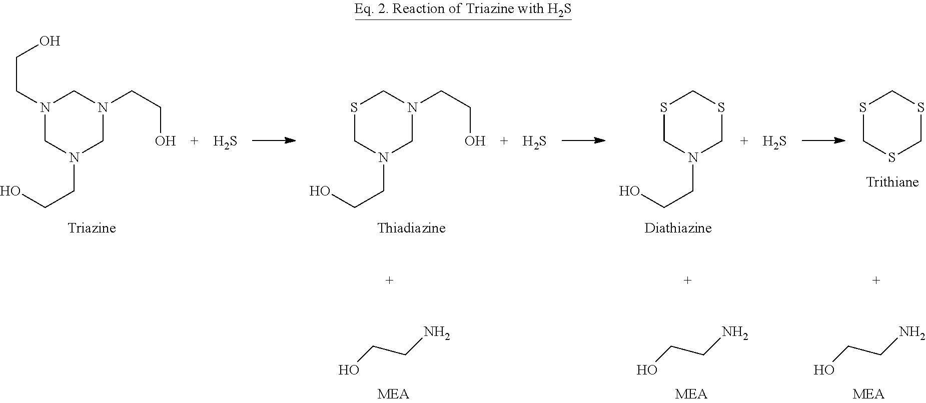

Other H₂S scavengers include polymeric, nitrogen-based products, aldehyde-based as well as non-nitrogen compounds. Most commonly used aldehydes include formaldehyde, acrolein, glyoxal, and glutaraldehyde. Functionalized aldehydes are also widely used. Combination products include amine-containing compound and a hemiacetal compound that can produce an aldehyde in situ. These are commonly used H₂S scavenging mixtures. Combination of triazine and glyoxal are also increasingly used in oil and gas facilities.

H₂S scavenger dose rate (injection rate) varies with the concentration of H₂S in the gas, the diameter and length of the loop line, the chemical used and the flow rate. Tests can be performed to determine the minimum residence time needed for a given sour gas/chemical combination at a given flow rate and these results used to determine the minimum length of loop line needed for full remediation.

Dose rate at a loop line is at least 4-5 times lower than a direct injection line for the same length, diameter, and flow rates, and can even be as low as 10% the levels used in straight line gas injection. For example, MEA-triazine chemistry can be dosed at a rate of 1-10 gallons per day for hydrogen sulfide levels of less than 250 ppm or less than 200 ppm, flow rates of 1-10 or 5 MMSCF, pipe lengths of at least 25 ft, at least 50 ft, at least 100 feet, and diameters of 1-10 or 2-6 inches. Dose rate of up to 15 gallons per day may also be used, prepending on length, diameter, flow rate and ppm of H₂S. Amine-glyoxal chemistry can also be dosed with similar dose rates. These dose rates are generally determined by experimental lab tests in simulated systems and confirmed by field trials.

The concentration of H₂S in the gas is preferably first measured after the gas exists the oil/water separator unit, but this may be omitted if the concentration is already known. After treatment with the H₂S scavengers in a loop line, concentration is again preferably measured. Quantitative analysis like gas chromatography and chemiluminescence are used for the measurement of H₂S gas. Commercially available H₂S analyzers can also be fitted on site that can measure H₂S concentration continuously and specifically quantify the H₂S levels. Lead acetate tape H₂S analyzers are popularly used as they are robust, compact and do not require frequent re-calibrations.

Any non-reactive, robust and flexible material can be used to make the loop line. Exemplary materials include high density polyethylene (HDPE), helically wound epoxy-free dry fiberglass, polyvinyl chloride (PVC), or polyethylene (PE). Ideal diameter for these piping in the loop line is 1-10 inches or even 12 inches, preferably about 2 inches to about 6 inches or about 4 inches. The number of loops in the loop line are dependent on factors such as the concentration of H₂S in the gas, flow rate, efficiency of scavenger chemistry, diameter of the line, diameter of the loop and the length of pipe needed for a given sour gas/chemical combination.

The piping is wound to a spool to both conserve space and to avoid turbulence and the scavenger falling out of the gas phase. Ideally, sufficient loops to provide at least 25 feet of non-turbulent piping are provided, but it may be 50 or 100 or more (up to 200, but preferably less), and may be less if the loop pipe is combined with straight piping. However, increased number of loops are preferred, which increases the overall length and thus the retention time of the H₂S scavenger chemicals in the pipeline. Retention time of about 4 h to about 20 h are expected with increasing number of loops. Retention times of about 6 h to about 12 h are preferred.

Plastic, wood, or preferably metal spools can be used for the loop piping. Generally, we prefer 6 to 12 ft diameter spools with a high weight rating, up to about 10-100 metric tons, would be preferred. However, 4- or 5-foot spools may also be used. If plastic piping is used, the spool may have a lower weight rating.

The invention includes any one or more of the following embodiments, in any combination(s) thereof.
A method of removing H₂S from natural gas, said method comprising introducing an H₂S scavenger upstream of a pipe loop, the pipe loop preferably at least 25 feet in length, said pipe loop having a uniform degree of curvature and lacking any 90° bends, said pipe loop transporting natural gas containing H₂S, wherein less H₂S scavenger is used in said pipe loop than in a straight pipe of a same length and a same diameter to bring an H₂S level to less than 1 ppm.
An improved method of removing H₂S from a natural gas pipe, said method comprising injecting an H₂S scavenger into a straight pipe flowing natural gas containing H₂S, said improvement comprising introducing an H₂S scavenger upstream of a pipe loop, said pipe loop wound around a spool having a core diameter of at least 6 feet and flowing a natural gas containing H₂S therein, wherein less H₂S scavenger is used in said pipe loop than in said straight pipe to bring an H₂S level to less than 1 ppm.
A method of removing H₂S from natural gas, said method comprising: a) measuring a concentration of H₂S at a first sampling point in a pipeline carrying natural gas plus H₂S; b) injecting an H₂S scavenger into a length of straight pipe in said pipeline; c) measuring a concentration of H₂S at a sampling point after said straight pipe; d) introducing additional H₂S scavenger upstream of a pipe loop in said pipeline and downstream of said straight pipe, said pipe loop having a uniform curvature; e) measuring a concentration of H₂S at a third sampling point after said pipe loop; f) collecting H₂S-free natural gas at a collection point after said third sampling point.
A method of removing H₂S from natural gas, said method comprising: a) measuring a concentration of H₂S at a first sampling point in a pipeline carrying natural gas plus H₂S; b) introducing H₂S scavenger upstream of a pipe loop in said pipeline, said pipe loop having a uniform curvature; c) measuring a concentration of H₂S at a second sampling point after said pipe loop; d) collecting H₂S-free natural gas at a collection point after said second sampling point.

Any method herein described, said pipe loop being of at least 25 ft, at least 50 ft, or at least 100 ft in length.

Any method herein described, said pipe loop being of shorter length than a straight line pipe of same diameter and flow rate and of a length that brings H₂S concentration to less than 1 ppm.

Any method herein described, said pipe loop wound around a spool can be oriented horizontally or vertically, but preferably vertical.

Any method herein described, said pipe loop wound around a spool of at least 4-5 ft in diameter, preferably at least 6 ft in diameter.

Any method herein described, wherein said H₂S scavenger is an amine, triazine, an aldehyde, or combinations thereof.

Any method herein described, wherein said pipe loop is composed of high density polyethylene (HDPE), fiberglass, epoxy-free dry fiberglass, polyvinyl chloride, polyethylene or combinations thereof.

Any method herein described, wherein said loop line has a diameter of 1-10 inches and a flow rate of 1-10 MMSCF, preferably about 2-6 inches in diameter and about 5 MMSCF.

Any method herein described, wherein said method is preceded by testing to optimize pipe length, diameter, flow rate, chemical identity and amount thereof before implementing the optimized values in a plant or pipeline or at a wellpad.

Any method herein described, wherein the collected H₂S-free natural gas is processed to form liquified natural gas (LNG).

As used herein “gas sweetening” or “gas scavenging” are processes to remove H₂S from gases. “H₂S mitigation” or “H₂S removal” are used interchangeably and refer to methods and strategies to remove H₂S from oil and gas.

As used herein a “loop line” is a line that provided a continuous low grade curve, so as to avoid turbulence and scavenger inactivation, and yet provide the long residence times needed without a large space commitment. We suggest a minimum spool diameter of at least 4-5 and preferably at least 6 ft (72″) as large metal spools are already available in the industry for carrying coiled tubing. Indeed, SPOOLTECH® (Houston, TX) has metal spools from 2 to 23 ft diameters and rated to as much as 95 metric tons. NOV® (Houston, TX) has smaller spools ranging from a 72-inch core holding 110,000 pounds, to a spool having a 98-inch core and holding 210,000 pounds. SONOCO® (Hartsville, SC) and DWELLOP® (Stavenger, Norway) also provide large high capacity spools, and there are many other commercial suppliers.

As used herein a “spool” or “reel” is shaped like a spool for holding thread, with an inner core, and outer flanges on each end to protect the piping wound thereon. It may also be provided with a frame to hold the spool and/or deploy the piping wound thereon, or the “spooler”—which allows spooling to be wound/unwound evenly—may be provided separately.

The use of the word “a” or “an” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim. The phrase “consisting of” is closed and excludes all additional elements. The phrase “consisting essentially of” excludes additional material elements, but allows the inclusions of non-material elements that do not substantially change the nature of the invention, such as instructions for use, buffers, and the like. Any claim or claim element introduced with the open transition term “comprising,” may also be narrowed to use the phrases “consisting essentially of” or “consisting of,” and vice versa. However, the entirety of claim language is not repeated verbatim in the interest of brevity herein.

The following abbreviations are used herein:

| ABBREVIATION | TERM |
|---|---|
| ASTM | American Society for Testing and Materials |
| CAPEX | Capital expenditure |
| DI | Direct Injection |
| EOR | Enhanced oil recovery |
| ft | Feet |
| HDPE | High density polyethylene |
| LNG | Liquified natural gas |
| MMSCF | Million standard cubic feet |
| OPEX | Operating expenditure |
| PE | Polyethylene |
| PPM | Parts per million |
| PVC | Polyvinyl chloride |

### BRIEF DESCRIPTION OF THE DRAWINGS

FIG. 1. Schematic of prior art treatment line (not drawn to scale) wherein at least 200 feet of straight pipe are needed, greatly increasing the footprint of the H₂S mitigation system.

FIG. 2. Schematic of straight line direct injection of H₂S scavenger chemical converted to have an added loop line. The footprint can be significantly reduced by the addition of a loop line. The second loop line is optional, but may be used where space needs dictate two smaller spools.

FIG. 3. Schematic of a loop line facility with minimal footprint.

FIG. 4. Photo of a loop line with multiple loops in a spool added to a direct injection facility.

### DETAILED DESCRIPTION

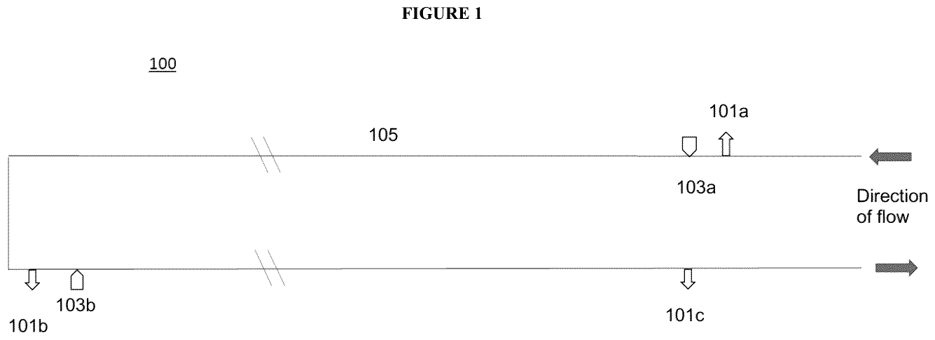

FIG. 1 shows a prior art straight pipe direction injection facility (100) with sampling ports (101a-c), and scavenger injection valves (103a-b). Since the straight pipe (105) needs to be at least 200 feet for efficacy of the scavenger, a considerable footprint is needed, although with the added sampling and injectors, the line could be 100 feet out and 100 feet in.

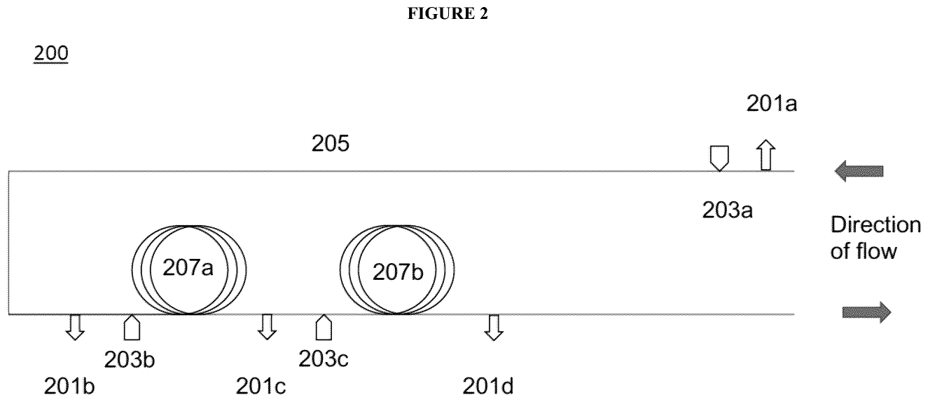

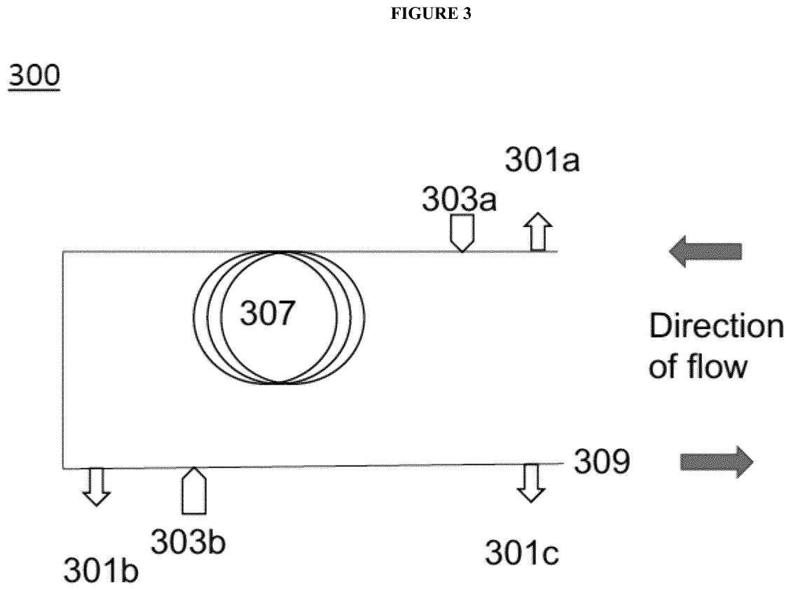

FIG. 2 details a typical straight line system converted by adding a loop line (200). The numbers are the same, but starting with the 200 series, so we have sampling ports (201a-d), and scavenger injection valves (203a-c). With the added loop (207a), the straight pipe (205) can be shorter as loop line (207a) compensates for the decreased length. In this converted system, footprint is reduced, but there is still a straight line, so it can be reduced further if built de novo with a loop line, as shown in FIG. 3.

In FIG. 2 we also show an optional second loop system (207b). As can be seen, testing for hydrogen sulfide content can be performed before injection, and then again after treatment. By testing at each stage, the optimal amount of hydrogen sulfide scavenger is added. We do not envision needing a second loop, but occasionally space needs may dictate two or more smaller loops instead of one larger loop, as may high levels of H₂S in the gas.

FIG. 3 shows a new loop line system (300). FIG. 3 shows sampling ports (301a-b), and scavenger injection valves (303), and loop line (307) compensates for the lack of straight pipe. In use, a sample is taken (301a) and concentration of H₂S is measured. A standard gas chromatography and chemiluminescence method as per ASTM D5504-01 or D6228-98 are used for measurement of H₂S concentration. An appropriate amount for scavenger is then injected (303a). Once the fluid has passed through the loop line (307), samples are taken again (301b). The hydrogen sulfide should be at or near zero, if the correct loop length, diameter, flow rate, and level of scavenger were determined in advance, but additional injection (303b) and sampling (301c) ports can be added in case of variance. Here, there is no need for straight pipe, and the footprint may be optimally reduced.

The gas with the H₂S scavenger travels through multiple loops of pipeline (307) for a retention time of a few minutes to a few hours. Depending on the overall length of the loop, the pipe diameter, the number of turns and the flow rate of the gas, the gas and H₂S scavenger mixture can travel from 6 h to about 12 h in the loop with minimal turbulence or loss of scavenger. With the loop line method, typically 0.5 to 0 ppm of H₂S would be detected at the second sampling point. Sweet gas is collected at the sweet gas outlet 309 and is sent for sale or storage as LNG.

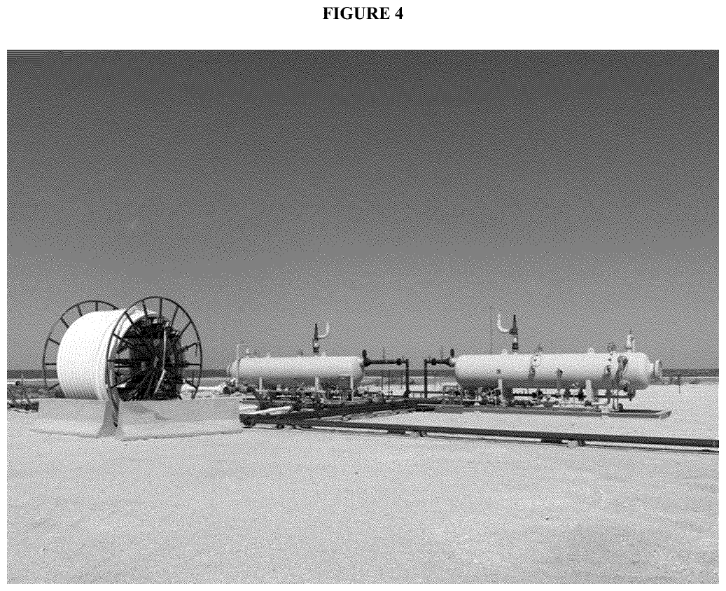

Although only three loops are shown in FIG. 3 for simplicity of illustration, a typical loop line has a spool with multiple loops wound around it, as shown in FIG. 4. FIG. 4 shows a perspective ground level view of a vertical loop line with multiple loops attached to a direct injection line.

### Loop Line in Conjunction with Direct Injection

In a recent application of this loop line method, two existing US shale gas facilities were chosen for fitting with a loop line. The fields A and B already had direct injection of H₂S scavenger amounting to more than 500 gallons/month of scavenger. However, the H₂S level in the gas after the DI of H₂S scavenger was still very high (35-40 ppm). To reach 0 ppm would have required an estimated 300-500 additional gallons of scavenger. The results of this application are shown below in Table 1.

TABLE 1
Direct Injection Method

| | | H₂S scavenger | |
|---|---|---|---|
| | | injection (gallons/ | H₂S level after |
| Field | H₂S level in gas | month) | treatment |
| A | 120 ppm | 700 | 35 ppm |
| B | 240 ppm | 1100 | 40 ppm |

To address the high hydrogen sulfide levels, Flexpipe™ (Farnham Quebec CA) loop made of high-density polyethylene, helically wound epoxy-free dry fiberglass, and a protective outer jacket was tested in the loop line method, although high density polyethylene or similar materials could also be used. The Flexpipe™ was installed in a natural gas wellpad, downstream of the straight pipe section.

Upon adding a loop line of same diameter, flow rate, with added injection of only about 110-120 gallons of the same chemicals, the H₂S levels in the sales gas reached 0 ppm, resulting in significant cost saving on scavenger chemicals. The results of this application are shown below in Table 2. As can be seen, we were able to obtain significant cost saving due to the increased efficiency of the loop system.

TABLE 2
Direct Injection with Loop Line Method

| | | H₂S scavenger | | |
|---|---|---|---|---|
| | | injection (through | | Yearly |
| | H₂S level | Loop Line) | H₂S level after | chemical |
| Field | in gas | (gallons/month) | treatment | saving |
| A | 120 ppm | 110 | 0 ppm | $270K |
| B | 240 ppm | 120 | 0 ppm | $490K |

### (Prophetic) Loop Line System

In a developing oil and gas facility with medium to low H₂S concentration, a loop line of appropriate material could be installed with no H₂S scavenger direct injection into straight line piping, and instead employing addition of chemicals at any suitable point upstream of the loop. A multi-loop system with a low injection of H₂S scavenger chemical is likely to remove all H₂S from the gas resulting in a 0 ppm level, provided that the pipe diameter, length, flow rate and chemical amounts are tested to provide optimal scavenging. We anticipate that 25-200, probably 100-150 feet of loop piping, with a 2-10, preferably 4-6-inch diameter and optimized flow rates, on a spool core of at least 6 feet diameter will be sufficient to reduce 200-250 ppm of hydrogen sulfide to near zero.

The examples herein are intended to be illustrative only, and not unduly limit the scope of the appended claims. Although the present disclosure and its advantages have been described in detail, it should be understood that various changes, substitutions and alterations can be made herein without departing from the scope of the disclosure as defined in the claims.

The following references are incorporated by reference in their entirety:
ELSHIEKH, T. M., et al. “Optimum injection dose rate of hydrogen sulfide scavenger for treatment of petroleum crude oil.” Egyptian Journal of Petroleum, 2015, 25, 75-78.
ELHATY, I. A. “Development in the scavenging efficiency of H₂S scavengers in oil and gas industry.” Nat. Volatiles & Essent. Oils, 2022, 9(2), 219-229.
ASTM D5504-01 Standard test method for the determination of sulfur compounds in natural gas and gaseous fuels by gas chromatography and chemiluminescence.

1. A method of removing H₂S from a fluid, said method comprising introducing an H₂S scavenger upstream of a pipe loop of at least 25 feet in length, said pipe loop having a uniform degree of curvature and lacking any 90° bends, said pipe loop transporting said fluid containing H₂S, wherein less H₂S scavenger is used in said pipe loop than in a straight pipe of a same length and a same diameter to bring an H₂S level to less than 1 ppm.

2. The method of claim 1, said pipe loop being of at least 50 or at least 100 feet in length.

3. The method of claim 1, said pipe loop is wound around a spool.

4. The method of claim 1, said pipe loop is wound around a spool of at least 4-5 feet or at least 6 feet in diameter.

5. The method of claim 1, wherein said H₂S scavenger is an amine, triazine, an aldehyde, or combinations thereof.

6. An improved method of removing H₂S from natural gas, said method comprising injecting an H₂S scavenger into a straight pipe flowing natural gas containing H₂S, said improvement comprising introducing an H₂S scavenger upstream of a pipe loop, said pipe loop wound around a spool having a core diameter of at least 6 feet and flowing a natural gas containing H₂S therein, wherein less H₂S scavenger is used in said pipe loop than in said straight pipe to bring an H₂S level to less than 1 ppm.

7. The method of claim 6, said pipe loop of at least 25 or at least 50 or at least 100 feet in length.

8. The method of claim 6, wherein said H₂S scavenger is an amine, triazine, an aldehyde, or combinations thereof.

9. A method of removing H₂S from natural gas, said method comprising:
a) measuring a concentration of H₂S at a first sampling point in a pipeline carrying natural gas plus H₂S;
b) injecting an H₂S scavenger into a length of straight pipe in said pipeline;
c) measuring a concentration of H₂S at a sampling point after said straight pipe;
d) introducing additional H₂S scavenger upstream of a pipe loop in said pipeline and downstream of said straight pipe, said pipe loop having a uniform curvature;
e) measuring a concentration of H₂S at a third sampling point after said pipe loop;
f) collecting H₂S-free natural gas at a collection point after said third sampling point.

10. The method of claim 9, wherein said pipe loop is composed of high density polyethylene (HDPE), fiberglass, epoxy-free dry fiberglass, polyvinyl chloride, polyethylene or combinations thereof.

11. The method of claim 9, wherein a total length of said straight pipe plus said pipe loop is at least 100 feet, preferably at least 200 feet.

12. The method of claim 9, wherein said loop line has a diameter of 1-10 inches and a flow rate of 1-10 MMSCF, preferably about 2-6 inches and about 5 MMSCF.

13. The method of claim 9, wherein said pipe loop is wound around a spool having a core of at least 6 feet in diameter.

14. The method of claim 9, wherein said H₂S scavenger is amine, triazine, an aldehyde, or combinations thereof.

15. The method of claim 9, wherein said collected H₂S-free natural gas is processed to form liquified natural gas (LNG).

16. A method of removing H₂S from natural gas, said method comprising:
a) measuring a concentration of H₂S at a first sampling point in a pipeline carrying natural gas plus H₂S;
b) introducing H₂S scavenger upstream of a pipe loop in said pipeline, said pipe loop having a uniform curvature;
c) measuring a concentration of H₂S at a second sampling point after said pipe loop;
d) collecting H₂S-free natural gas at a collection point after said second sampling point.

17. The method of claim 16, wherein said pipe loop is composed of high density polyethylene (HDPE), fiberglass, epoxy-free dry fiberglass, polyvinyl chloride, polyethylene or combinations thereof.

18. The method of claim 16, wherein a total length of said pipe loop is at least 25 feet, at least 50 feet or at least 100 feet, and is preferably less than 200 feet.

19. The method of claim 16, wherein said loop line has a diameter of 1-10 inches and a flow rate of 1-10 MMSCF, preferably about 2-6 inches and about 5 MMSCF.

20. The method of claim 16, wherein said pipe loop is wound around a spool having a core of at least 6 feet in diameter.

21. The method of claim 16, wherein said H₂S scavenger is amine, triazine, an aldehyde, or combinations thereof.

22. The method of claim 16, wherein said collected H₂S-free natural gas is processed to form liquified natural gas (LNG).
